(19) United States
(12) Patent Application Publication
(10) Pub. No.: US 2016/0253602 A1
(43) Pub. Date: Sep. 1, 2016

(54) SYSTEM AND METHOD FOR FACILITATING PROMOTION OF GOODS AND SERVICES

(71) Applicant: Doron Koren, Kfar Sirkin (IL)

(72) Inventor: Doron Koren, Kfar Sirkin (IL)

(21) Appl. No.: 15/057,108

(22) Filed: Feb. 29, 2016

Related U.S. Application Data
(60) Provisional application No. 62/121,645, filed on Feb. 27, 2015.
(60) Provisional application No. 62/274,101, filed on Dec. 31, 2015.

(51) Int. Cl. G06Q 10/02; G06Q 30/02; G06Q 30/06

(52) U.S. Cl. CPC G06Q 10/02; G06Q 30/0631; G06Q 30/0222; G06Q 30/0609

(57) ABSTRACT

A method for compensating a promoter for recommending a provider to a patron entails use of communicatively coupled applications on a promoter's phone and a provider's computing device. The provider selects the promoter on behalf of a patron and causes a unique code to be sent to the patron's cell phone. The patron presents the code to the provider at the time of patronage, at which time the provider pays the promoter an amount communicated to the promoter's application prior to the selection.

### RELATED APPLICATION

This application is a nonprovisional of and claims the benefit of priority of U.S. Provisional Application 62/121,645 filed 27 Feb. 2015, the entire contents of which are incorporated herein by this reference and made a part hereof, and U.S. Provisional Application 62/274,101 filed 31 Dec. 2015, the entire contents of which are incorporated herein by this reference and made a part hereof.

### FIELD OF THE INVENTION

This invention relates generally to promotion of goods and services, and, more particularly, to a computerized system to facilitate, track and reward recommendations of goods and services.

### BACKGROUND

Many businesses benefit from recommendations by others. For example, restaurants, hotels and attractions benefit from recommendations by taxi cab drivers and hotel concierge personnel to passengers and guests. However, heretofore there has been no tool for facilitating such recommendations and managing the relationship between the promoter (e.g., concierge or cab driver) and the provider of goods and services (e.g., restaurants, lodging establishments and attractions). Typically, the promoter expects some form of compensation (e.g., a gratuity) for the recommendation, while the provider does not want to compensate the promoter unless the party receiving the recommendation procures goods or services from the provider. Unfortunately, heretofore there has been no tool for confirming the procurement.

What is needed is a tool that allows a provider to manage, in real time, the compensation being offered for recommendations. The tool should also provide a means for both the promoter and provider to determine when a consumer procures goods or services from the provider based upon a recommendation from the promoter. The tool should also enable payment to the promoter as compensation for the recommendation. The tool should also provide a means for communicating a unique data object (e.g., a code or coupon) to a portable electronic device of the consumer (e.g., a smartphone) for the consumer to present to the provider when the consumer procures the goods or services.

The invention is directed to overcoming one or more of the problems and solving one or more of the needs as set forth above.

### SUMMARY OF THE INVENTION

To solve one or more of the problems set forth above, in an exemplary implementation of the invention, a system and method are provided for compensating a promoter for recommending a provider to a patron. The promoter and provider use software applications executing on computing devices such as cellular phones (e.g., smartphones) to communicate information, requests and approvals and effectuate payment. The provider's application allows the provider to describe the provider's services, specify compensation for a referred patron, and consider (i.e., accept or reject) reservations for patronage communicated from a promoter. The promoter's application allows the promoter, in consultation with a patron, to select a provider, and to communicate a reservation request to a selected provider's application. A unique data object is communicated to a patrons phone. The patron presents the unique data object to the provider at the time of patronage. Upon such presentation of the unique data object, the provider pays the promoter the specified compensation for the patronage. Using the provider's application, the provider may upload one or more coupons to be provided to the promoter for use by a prospective patron, to encourage patronage.

An exemplary compensating promotion system according to principles of the invention includes a provider application executing on a provider computing device in the possession of a provider, a promoter application executing on a promoter cellular phone in the possession of a promoter, and a patron cellular phone configured to wirelessly receive objects. The promoter application, via promoter use, selects an identification of the provider from a plurality of identifications of available providers, the patron electing to provide patronage to the provider. The promoter application causes a unique object to be sent to the patron cellular phone. The provider application causes a payment to be made to the provider upon presentation of the unique object to the provider by the patron at a time of patronage. The unique object may be numeric data, alphanumeric data, coupon data or barcode data.

The promoter application may communicate a reservation request to the provider application, the reservation request corresponding to the time of patronage. The provider application communicates an acceptance or rejection of the reservation request to the promoter application, in the case of rejection, an alternative reservation proposal may be provided along with the rejection of the reservation request to the promoter application.

The payment to be made to the provider upon presentation of the unique object to the provider by the patron at a time of patronage may be a payment predetermined by the provider and communicated to the promoter application. The payment may be an amount that varies according to the day and/or time of patronage. The provider may adjust the amount according to the providers needs and goals.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram of communicatively coupled devices of an exemplary system to facilitate, track and reward recommendations of goods and services according to principles of the invention; and

FIG. 2 is a high level block diagram of communicatively coupled software components of an exemplary system to facilitate, track and reward recommendations of goods and services according to principles of the invention; and

FIG. 3 is a high level block diagram of functions of software components of an exemplary system to facilitate, track and reward recommendations of goods and services according to principles of the invention; and

FIG. 4 is a high level flowchart of functions of an exemplary promoter application for an exemplary system to facilitate, track and reward recommendations of goods and services according to principles of the invention; and

FIG. 5 is a high level flowchart of functions of an exemplary provider application for an exemplary system to facilitate, track and reward recommendations of goods and services according to principles of the invention; and

FIG. 6 is a high level flowchart of functions of an exemplary back end for an exemplary system to facilitate, track and reward recommendations of goods and services according to principles of the invention; and

FIG. 7 is a schematic that conceptually illustrates elements of an exemplary screen display for a promoter application for an exemplary system to facilitate, track and reward recommendations of goods and services according to principles of the invention; and

FIG. 8 is a schematic that conceptually illustrates elements of an exemplary screen display for a provider application for an exemplary system to facilitate, track and reward recommendations of goods and services according to principles of the invention; and

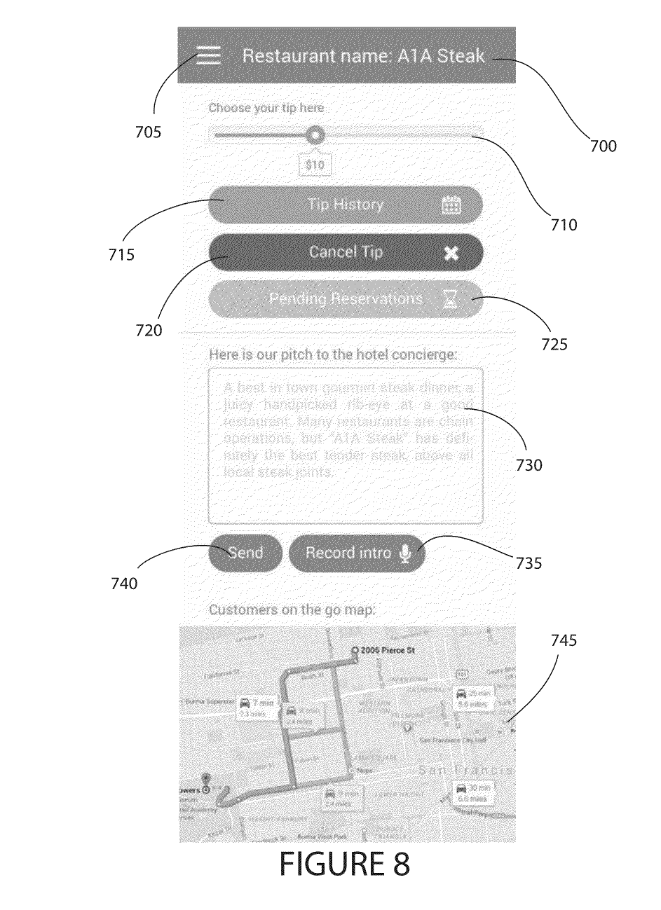

FIG. 9 is a high level flowchart of functions of another exemplary provider application for an exemplary system to facilitate, track and reward recommendations of goods and services according to principles of the invention; and

FIG. 10 is a high level flowchart of functions of another exemplary promoter application for an exemplary system to facilitate, track and reward recommendations of goods and services according to principles of the invention; and

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

A system and method according to principles of the invention enables providers of goods or services, referred to herein as “providers,” to reward third parties for recommending their goods or services to consumers who actually procure the goods or services based upon the recommendation. Third parties who recommend the goods or services are referred to herein as “promoters.” Nonlimiting examples of promoters are taxi cab drivers, concierges, and any other professional that routinely directs consumers to local businesses. The goods or services are referred to herein as “services” for convenience. Nonlimiting examples of “services” include lodging, restaurant, transportation, sightseeing and entertainment services, as well as goods such as foods, beverages, jewelry, clothing and other products. Consumers who actually procure services based upon the recommendation of a promoter are referred to herein as “patrons.” The act of procuring services based upon the recommendation of a promoter is referred to herein as “patronage.”

A system and method according to principles of the invention enables providers to offer compensation to promoters to encourage promoters to recommend the services of the provider to consumers. Upon patronage by a patron in response to a promoter's recommendation, the promoter who recommended the patron may be compensated. Providers may adjust the offered compensation, in real time, to increase or decrease recommendations, depending upon the capacities and needs of their businesses.

A system according to principles of the invention enables providers to pay compensation to promoters only after a patron has proceeded with patronage, upon recommendation from a promoter. The recommendation process provides a unique code or object to the patron to be used at the time of patronage. The code or object is associated with the promoter and the patron. The provider does not pay the compensation unless the patron has proceeded with patronage.

A system and method according to principles of the invention enables providers to offer discounts (e.g., coupons) to consumers to encourage patronage. Providers may adjust the offered discounts, in real time, to increase or decrease patronage, depending upon the capacities and needs of their businesses. Providers may personalize the coupons. Such coupons are referred to as intrinsic or personalized coupons because they belong to a particular patron. The personalized coupon may be used only by a particular patron, to encourage and reward that patron's timely patronage upon recommendation by a promoter.

A system and method according to principles of the invention enables promoters to search for and sort through participating providers, according to types of services, geographical proximity, ratings, compensation offered to the promoter, coupons offered to patrons and any other category associated with provider listings. Thus, a promoter may recommend, to a consumer, a nearby provider that offers an acceptable compensation to the promoter, and offers a service of interest to a consumer, and possibly offers a coupon to encourage and reward patronage.

A system and method according to principles of the invention enables promoters to make reservations on behalf of patrons. A reservation reduces or eliminates wait time and encourages the patron to follow through with patronage. Reservations are subject to review and acceptance by providers. Alternate reservation times may be proposed by a provider.

An implementation of the present invention may be embodied in hardware and/or in software (including firmware, resident software, micro-code, etc.). Furthermore, the present invention may take the form of one or more computer program products on one or more computer-usable or computer-readable storage media having computer-usable or computer-readable program code embodied in the media for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific non-limiting examples (a non-exhaustive list) of a computer-readable medium include random access memory (RAM), a read-only memory (ROM), an erasable programmable read-only memory (EPROM or Flash memory), a hard disk drive, a solid state drive, a portable compact disc read-only memory (CD-ROM), a Blu-ray disc (BD). In a preferred implementation, the provider and promoter functions as described below are enabled through computers software executable on a portable electronic device such as a smartphone or tablet, and, optionally, also on a personal computer. The back end may be implemented as software executable on a personal computer and/or web server.

Computer program code or “code” for carrying out operations (e.g., steps) according to the present invention may be written in any programming language compatible with the corresponding computing devices and operating systems. Software embodiments of the present invention do not depend on implementation with a particular programming language.

The computer program code may be provided to a processor of a general-purpose computer, special purpose computer, or other programmable computing apparatus (e.g., a phone, personal digital assistant, tablet, laptop, personal computer, or computer server) as instructions to produce a machine, such that the instructions, which execute via the processor of the computer or other programmable data processing apparatus, create means for implementing the functions specified in the illustrations. The computer code may be stored in a computer-readable memory that can direct a computer or other programmable data processing apparatus to function in a particular manner, such that the instructions stored in the computer-readable memory produce an article of manufacture including instruction means which implement the functions and perform the steps specified in the illustrations and described herein.

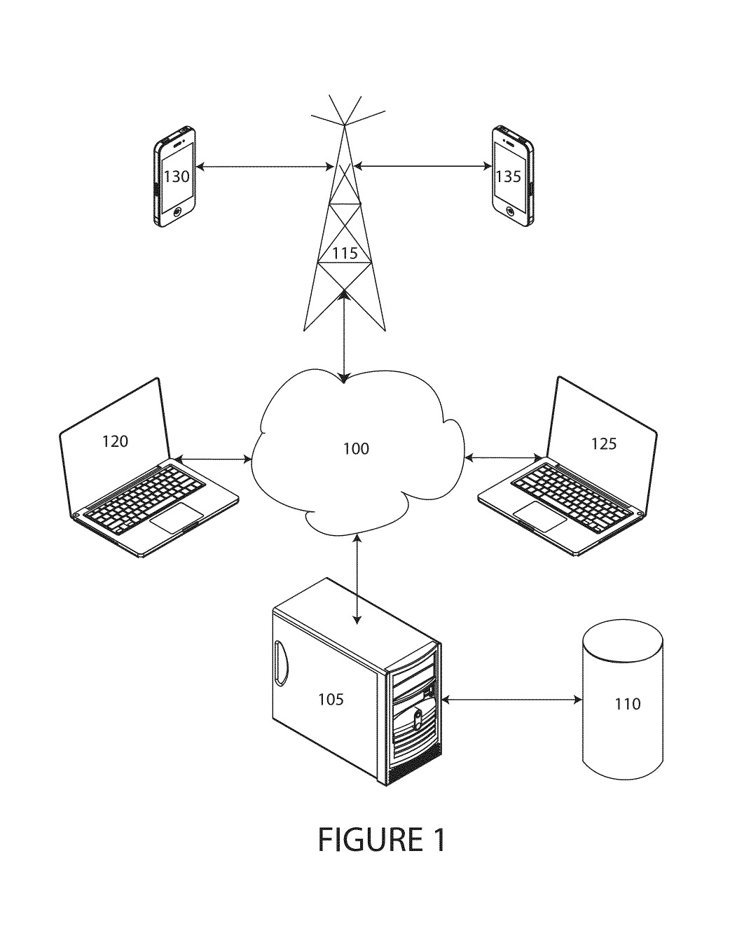

Referring now to FIG. 1, a high level block diagram of hardware components of a system according to principle of the invention is conceptually illustrated. Consistent with the present invention, providers and promoters use computing devices, such as a cellular phones 130, 135, tablets, and/or personal or laptop computers 120, 125, communicating in a wireless or wired mode via the Internet 100. The computing devices (i.e., clients or client devices) are equipped with software for inputing and displaying information in accordance with the methodologies described herein. Such software may comprise a web browser and/or a mobile device app. Some of the computing devices 130, 135 may be equipped with cellular wireless communication modules providing internet access via wireless cellular communication infrastructure 115. Some of the computing devices may be equipped with Global Positioning System (“GPS”) receivers for receiving signals from GPS satellites to determine location of the device. The devices 120-135 are communicatively coupled to a web server 105, which may access a data storage 110 containing a database of information relevant to the functions and transactions described herein. The purpose of the server is managing the interaction between promoters and providers, such as reservation initiation, information advertising, transactions, payments, storing user data and sending alerts and notifications.

Some computing devices may not have access to a GPS service (for example, they may lack hardware necessary to support such a service or they may not be in a location where adequate GPS signals can be receive); consequently, such GPS information may not be available for all devices. GPS services do not operate well in certain locations, particularly indoors. Thus, even if a device does have the necessary hardware and software to support a GPS service, occasionally GPS information from the GPS service may not be available to a particular device 120-135.

IP trace information may include the public IP address of the device 120-135 and the set of IP addresses that data packets sent from the device 120-135 pass through to reach web server 105. The public IP address of the device 120-135 may be determined by gathering the source IP address from the server socket receiving the device 120-135 connection. The list of hops through which the data packets sent from the device 120-135 go through may be determined by sending adaptive TTL (time to live) UDP packets to server 105 from the device 120-135. In order to determine if the device 120-135 is being an IP proxy, server 105 may correlate the list of hops with the public IP address of the device 120-135. In this way, server 105 may effectively discover the real public IP address of the device 120-135. The real public IP address of the device 120-135 is then matched against a database of Internet Service Providers (ISPs) which returns the probable address of the originating device 120-135 message. This probable address of the originating device 120-135 message may then be translated to a set of longitude and latitude coordinates.

Triangulation information for a device 120-135 may include a list of public Wi-Fi access points surrounding the device 120-135 as well as the signal strength of each Wi-Fi access point accessible by the device 120-135. The list of surrounding Wi-Fi access points, and their signal strength, may be formatted and correlated with a database of public Wi-Fi access points by server 105 to determine a probable set of longitude and latitude coordinates for the device 120-135. The database of public Wi-Fi access points employed by server 105 may be updated over time to reflect new information about available Wi-Fi access points.

Cellular tower identification and location information through which mobile cellular devices 130, 135 access the Internet, may also be used to determine location. Additionally, a user may specify their location (e.g., address or city or zip code or area code) during account setup. By way of example, a promoter who drives a cab in Manhattan may specify New York, N.Y. as his or her area of interest during account setup. Regardless of how the system determines location, the user's locale is used to populate the provider list with local providers.

While each of these different types of data may be used by server 105 to identify a current location for a device 120-135, certain types of data may be more accurate or reliable than others. GPS information is more accurate and indicative of the correct physical location of a device 120-135; however, as explained above, GPS information for a particular device 120-135 may not always be available. Triangulation information, while not as accurate and reliable in identifying the correct physical location of a device 120-135 as GPS information, is more accurate and reliable than IP trace information. However, triangulation information also may not always be available, e.g., the device 120-135 may not be able to detect any nearby recognizable Wi-Fi access points. Additionally, while IP trace information is less accurate than either GPS information or triangulation information in determining the correct location of a device 120-135, it is always obtainable if the device 120-135 can communicate to server 105 over the Internet.

Additionally, a consumer may input location (e.g., an address) for a device, such as a personal computer, laptop 140 or tablet 135, that may not be equipped with a GPS receiver. For a device, such as a personal computer or laptop 120, 125, which may be at a fixed location (e.g., in a restaurant), the location of the device may be known (i.e., the address may be provided during account setup) and associated with a unique identifier (e.g., MAC address) for the device.

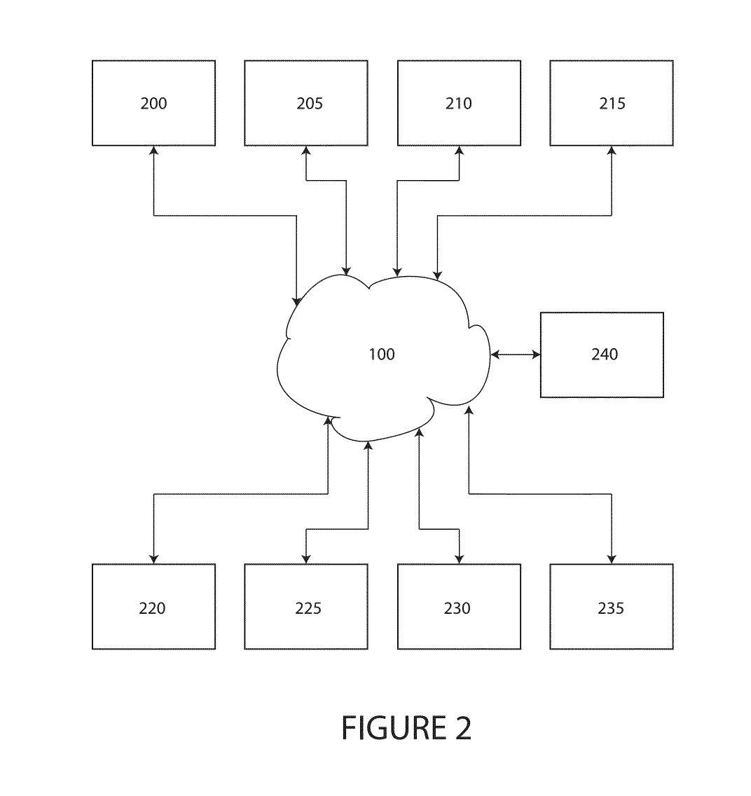

FIG. 2 is a high level block diagram of communicatively coupled software components of an exemplary system to facilitate, track and reward recommendations of goods and services according to principles of the invention. Promoters use a software application 200-215 to perform promoter functions (described below). As illustrated in FIG. 2, many promoters may use a promoter application 200-215 to perform promoter functions simultaneously. The software application 200-215 used by promoters may be an application designed specifically and only for use by promoters, or an application designed for use by either promoters or providers but that can be configured for use by promoters. As used herein applications designed or configured to perform one or more promoter functions, as described herein, are each referred to as a “promoter app.” In FIG. 2, promoter apps 200-215 have access to the internet 100, through which the promoter apps may send and receive data.

Providers use a software application 220-235 to perform provider functions (described below). As illustrated in FIG. 2, many providers may use a provider application 220-235 to perform provider functions simultaneously. The software application 220-235 used by providers may be an application designed specifically and only for use by providers, or an application designed for use by either promoters or providers but that can be configured for use by providers. As used herein applications designed or configured to perform one or more provider functions, as described herein, are each referred to as a “provider app.” In FIG. 2, provider apps 220-235 have access to the internet 100, through which the provider apps may send and receive data.

Web server software 240 running on a web server provides back-end functionality, as described below. Such software is referred to herein as a “back-end app.” While one web server software application 240 is illustrated in FIG. 2, the invention is not limited to a single web server software application. Rather back-end functions may be performed by one or more web servers running one or more instances of a back-end app. Additionally, back-end functions may be distributed across several computing devices and applications.

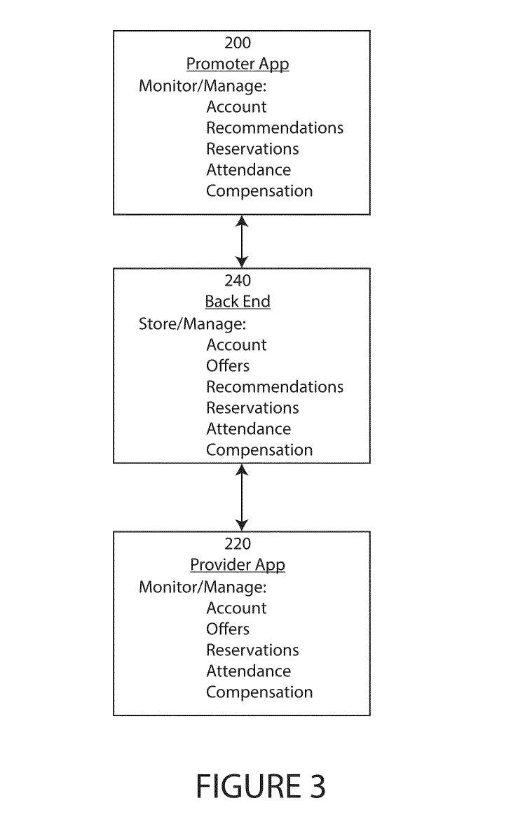

Referring now to FIG. 3, a high level block diagram of functions of software components of an exemplary system to facilitate, track and reward recommendations of goods and services according to principles of the invention. Promoter app 200 functions may include account management and monitoring. A promoter may enter personal and financial account information. The information is used to identify the promoter and to compensate the promoter for patronage from patrons recommended by the promoter. Such information may include contact information (e.g., an email address and cellular telephone number), a user name and password for authorized access and use, and account information for receipt of payments from providers. A promoter may monitor changes, such as payments received on the promoter's account. Monitoring may entail receiving notifications (e.g., SMS, email and/or pop-up notifications).

A promoter app 200 also provides recommendation functionality. Using such functions, the promoter may determine a provider to recommend to a patron. Recommendation functions include searching and sorting, as well as selection. Optionally, tabular comparisons of selected provider candidates may be available. The recommendation function allows a promoter to search for, scroll through and sort providers. The promoter app may be configured to request local providers (e.g., within a certain geographic area by zip codes, area codes, or other geographical designations). Data is supplied from the back-end app. Provider listings include information about the compensation to be earned by the promoter for a successful recommendation leading to patronage. Additional information, such as coupons, specials, ratings, average cost (e.g., entree cost), dress code and the like may be displayed. Information about a recommended provider may be sent (e.g., via email or SMS) to the passenger's smart phone. A code (“recommendation code”) to be used by the passenger at the provider's business is sent (e.g., via email or SMS) to the passenger's smart phone. The recommendation code may comprise alphanumeric characters, a barcode capable of being optically processed, or some other object that uniquely identifies the transaction. The back-end may store, and associate with a unique transaction identification (which may the same as the recommendation code), the promoter's identification and the passenger's contact information (email and/or cellular telephone number).

Illustratively, using the promoter app 200, a promoter, such as a cab driver, may search for a nearby Japanese restaurant to recommend to a tourist passenger who has inquired about any such restaurants in the area. From the searched results, the cab driver may recommend a restaurant. Information about the recommended restaurant and a recommendation code may be sent (e.g., via email or SMS) to the passenger's smart phone. Upon such recommendation, the cab driver will earn compensation from the restaurant for the passenger's patronage, provided that the recommendation code is used by the passenger at the time of patronage. To encourage use of the code, a reservation may be honored or a discount or special may be available upon use of the code.

The promoter app 200 also provides reservation functionality. Using such a function, the promoter may make a reservation (e.g., schedule an appointment) with a provider. Reservation functions include submitting a proposed date, time and service request to a provider. The service request may provide details about the service requested, such as attendees for a meal in a restaurant (e.g., 2 adults and 2 children). A provider may accept or reject the proposed date and time. In the event of an acceptance, a notification is sent to the promoter and/or the patron. In the event of rejection, a notification is sent to the promoter and/or the patron. Optionally, a rejection notice may also include an alternative date or time proposed by the provider. If the recipient of the rejection notice with the alternative date or time is accepted by the recipient, the provider is notified of the acceptance. If the recipient of the rejection notice with the alternative date or time is rejected by the recipient, the provider is notified of the rejection. The process of proposal followed by acceptance or rejection, followed by possible alternative proposal, may be repeated until a reservation acceptable to the patron and provider is determined. Notifications may be provided app to app, or via email or SMS.

The promoter app 200 also provides attendance functionality. Promoters are notified upon patronage from a recommendation. This is referred to as the attendance function. The patron uses the recommendation code at the time of patronage, by presenting the recommendation code to the provider. The provider enters the recommendation code in the provider app 220, or otherwise indicates that the provider has received the recommendation code or patronage from the patron or for the particular recommendation transaction. Additionally, the system may detect patron presence at the provider using any location technology (e.g., GPS) as described above. The presence may be recorded at the back-end and, optionally, trigger a patronage notification as described above.

The promoter app 200 also provides compensation functionality. Promoters are compensated upon patronage from a recommendation. The amount of compensation is the amount specified in the provider's listing. The compensation may automatically be paid into an account of the promoter. The account may be an account within the system, or a separate account such as a banking account or Paypal® account for the promoter. Promoters may be notified when such compensation is received in the account.

A provider app 220 includes account management and monitoring. A provider may enter personal and financial account information. The information is used to identify the provider and to process payments by the provider to compensate promoters for patronage from patrons recommended by the promoters. Such information may include contact information (e.g., an email address and cellular telephone number), a user name and password for authorized access and use, and account information for making payments. A provider may monitor changes, such as payments made on the provider's account. Monitoring may entail receiving notifications (e.g., SMS, email and/or pop-up notifications).

The provider app 220 provides offer functionality. An offer is a listing. The listing identifies the provider, the services offered by the provider, the compensation offered by the provider for recommendations that lead to patronage, and any coupons, discounts or specials offered by the provider. The system provides a form for providers to create new offers. The form solicits information needed for an offer. Graphics, documents and other files related to the offer may be uploaded through the form. A provider may add, delete and modify offers in real time. Offers are stored by the back-end and communicated to promoters by the back-end. Offers are effective when saved. The back-end may check validity of an offer at the time of a recommendation, to make sure that the offer has not been deleted or modified just prior to the recommendation. If an offer changes, the updated offer may be provided to the promoter.

The provider app 220 also provides reservation functionality. Using such a function, the provider receives proposed reservations and may accept or reject a proposed reservation from a promoter for a patron. Reservation proposal functions include submitting a proposed date, time to a promoter for a service requested by a patron. In the event of an acceptance of a proposed date and time, a notification is sent to the promoter and/or the patron. In the event of rejection, a notification is sent to the promoter and/or the patron. Optionally, a rejection notice may also include an alternative date or time proposed by the provider. If the recipient of the rejection notice with the alternative date or time is accepted by the recipient, the provider is notified of the acceptance. If the recipient of the rejection notice with the alternative date or time is rejected by the recipient, the provider is notified of the rejection. The process of proposal followed by acceptance or rejection, followed by possible alternative proposal, may be repeated until a reservation acceptable to the patron and provider is determined. Notifications may be provided app to app, or via email or SMS.

The provider app 220 also provides attendance functionality. Promoters are notified upon patronage from a recommendation. A patron uses a recommendation code at the time of patronage, by presenting the recommendation code to the provider. The provider enters the recommendation code in the provider app 220, or otherwise indicates that the provider has received the recommendation code or patronage from the patron or for the particular recommendation transaction. The promoter is notified upon patronage. Additionally, the system may automatically detect patron presence at the provider using any location technology (e.g., GPS) as described above. The presence may be recorded at the back-end and, optionally, trigger a patronage notification as described above.

The provider app 220 also provides compensation functionality. Promoters are compensated upon patronage from a recommendation. The amount of compensation is the amount specified in the provider's listing. The compensation may automatically be paid into an account of the promoter. The account may be an account within the system, or a separate account such as a banking account or Paypal® account for the promoter. Providers may be notified when such compensation is paid.

The back-end 240 stores data related to all functions, provides data necessary for promoter app and provider app functions, and negotiates transmission of notices. Provider and promoter account information are stored by the back-end 240. Data for offers created by providers are stored by the back-end 240. Data for recommendations by promoters are recorded and stored by the back-end 240. The back-end 240 causes the provider to be notified of promoter recommendations. The back-end also transmits information for a recommendation to a patron. Data for reservations is transmitted, recorded and stored by the back-end 240. The back-end 240 stores data for accepted reservations. Data for proposed reservations may be communicated directly directly between promoter and provider, or indirectly to the back-end for forwarding between promoter and provider. Attendance data is received from a provider and stored by the back-end 240. The attendance data includes the recommendation code, provider identification, promoter identification and date and time of attendance. Compensation is managed and effectuated by the back-end. Provider payments are sent to the back-end or to an account managed by the back-end, which may deduct a fee and pay the balance, equal to the offered compensation, to the provider.

The promoter app 200 also provides compensation functions 345. User information for the promoter's account is set by the promoter. Promoters are compensated upon patronage from a recommendation 355. The amount of compensation is the amount specified in the provider's listing. The compensation may automatically be paid into an account of the promoter. The account may be an account within the system, or a separate account such as a banking account or Paypal® account for the promoter. Promoters may be notified when such compensation is received in the account.

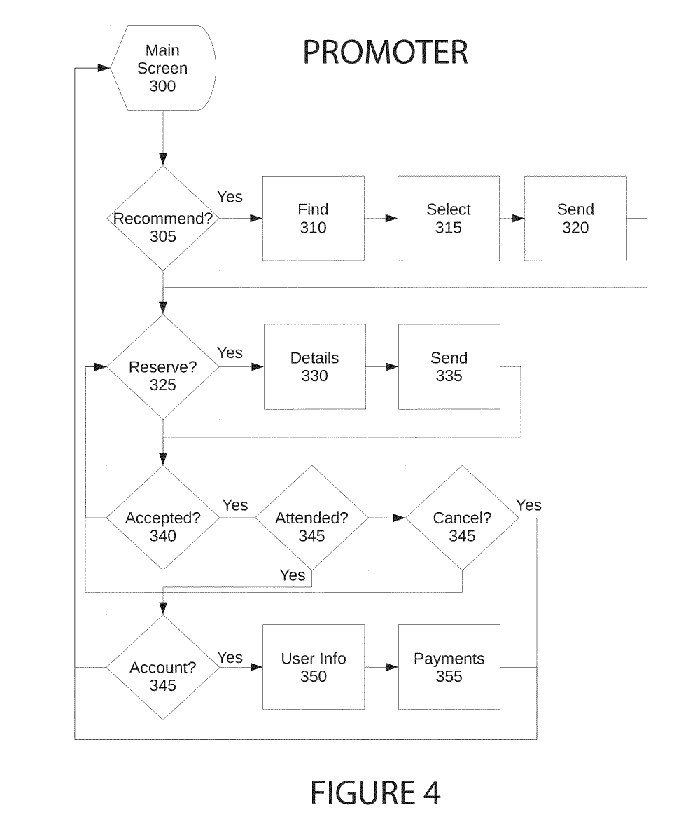

Referring now to FIG. 4, a high level flowchart of functions of an exemplary promoter application 200 for an exemplary system to facilitate, track and reward recommendations of goods and services according to principles of the invention is provided. The promoter application 200 displays a main screen 300 from which various functions may be selected using any user interface available for making selections. If a promoter selects recommendation 305, control passes to searching 310 and selection 315 tools. Searching (aka finding) entails querying offers stored in the back-end. By way of example and not limitation, a query may seek offers relating to a particular service within a vicinity of the promoter. Sorting and filtering controls may be provided to arrange and focus search results. Upon selecting an offer for a recommendation, the recommendation data is sent 320 to and stored by the back-end and communicated to the provider and/or patron.

If a promoter selects reserve 325, control passes to tools for proposing and accepting or rejecting reservation data. Details for a proposed reservation 330 are set by a promoter and sent 335 to a provider for consideration. By way of example and not limitation, a promoter may propose a reservation for two adults and two children at a selected Japanese restaurant. The proposed reservation details are sent to the restaurant, as the provider, for the restaurant's consideration. Reservation details may also be sent to and stored by the back-end.

The promoter application also manages acceptances 340. If an attended notification is received, indicating that a patron has completed patronage at a recommended provider, the promoter is notified 345. If a potential patron does not complete patronage, e.g., at a reserved day and time, the promoter is notified 345 and given the option of contacting the potential patron to discuss canceling the recommendation and/or reservation or rescheduling a reservation.

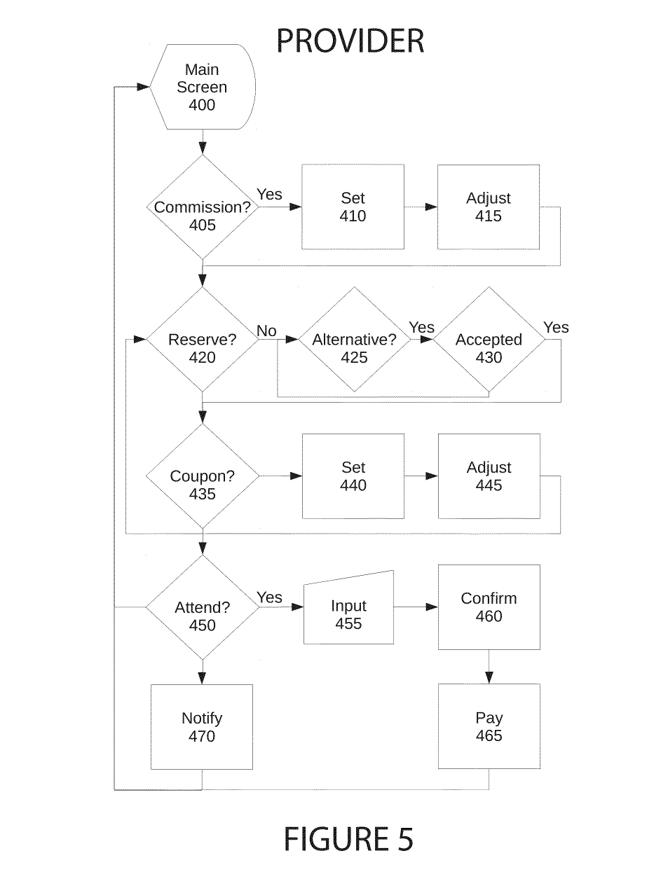

Referring now to FIG. 5, a high level flowchart of functions of an exemplary provider application 220 for an exemplary system to facilitate, track and reward recommendations of goods and services according to principles of the invention is provided. The provider application 200 displays a main screen 300 from which various functions may be selected using any user interface available for making selections. If a provider selects commission 405, control passes to offer creation 410 and modification 415 tools. A provider may enter personal and financial account information. The information is used to identify the provider and to process payments by the provider to compensate promoters for patronage from patrons recommended by the promoters. Such information may include contact information (e.g., an email address and cellular telephone number), a user name and password for authorized access and use, and account information for making payments. A provider may monitor changes, such as payments made on the provider's account. Monitoring may entail receiving notifications (e.g., SMS, email and/or pop-up notifications). An offer is a listing prepared by the provider. The listing identifies the provider, the services offered by the provider, the compensation offered by the provider for recommendations that lead to patronage, and any coupons, discounts or specials offered by the provider. The system provides a form for providers to create new offers, modify prior saved offers, and activate and deactivate prior offers. Only activated offers are made accessible to promoters. A provider may add, delete and modify offers in real time. Thus, when business is slow, a provider may enhance offers to encourage recommendations and patronage. Such enhancement may entail increasing the compensation offered to promoters for recommendations leading to patronage and offering discounts or specials for patrons. Offers are stored by the back-end and communicated to promoters by the back-end. Offers are effective when saved. The back-end may check validity of an offer at the time of a recommendation, to make sure that the offer has not been deleted or modified just prior to the recommendation. If an offer changes, the updated offer may be provided to the promoter.

If a provider selects reserve 420, control passes to tools for managing, accepting or rejecting and proposing reservation data. Details for a proposed reservation 330 are set by a promoter and sent 335 to a provider for consideration. If a provider rejects a reservation 430, the promoter may propose an alternative reservation date and time 425 for consideration by the promoter in collaboration with the potential patron. By way of example and not limitation, a provider may propose a reservation for two adults and two children at a selected Japanese restaurant at 7:00 pm. The proposed reservation details are sent to the restaurant, as the provider, for the restaurant's consideration. Reservation details may also be sent to and stored by the back-end. If the provider cannot accommodate the proposed reservation, the provider may propose an alternative time, e.g., 6:00 pm. The potential patron, through the promoter, may accept or reject the proposed alternative. Upon rejection, the promoter may send an alternative or wait for the provider to propose another alternative.

The provider application also manages coupons 435, also referred to herein as discounts or specials. The provider may create 440 and modify 445 a coupon to be associated with an offer and commission. When issued in response to a reservation and/or recommendation, the coupon is personal to the patron and associated with the recommendation code. The coupon can only be used with the recommendation code, which is unique to a patron. In this manner, the provider is in control of exactly how many coupons it may have to honor. A provider may create a plurality of coupons and issue them as deemed appropriate to entice patronage. When business is slow, the provider may issue more coupons than when business is robust and the provider lacks any unused capacity.

The provider app 220 also provides attendance functions 450. Promoters are notified upon patronage from a recommendation. A patron uses a recommendation code at the time of patronage, by presenting the recommendation code to the provider. The provider enters 455 the recommendation code in the provider app 220, or otherwise indicates that the provider has received the recommendation code or patronage from the patron or for the particular recommendation transaction. Confirmation 460 entails notifying the promoter of the patronage. Upon confirmation, the provider pays 465 the promoter for the recommendation. However, if the potential patron does not attend, either when scheduled for a reservation or a determined amount of time after the recommendation, the promoter may be notified 470. Upon notification, the promoter has opportunity contact the potential patron to determine if the patron failed to attend but may like to reschedule.

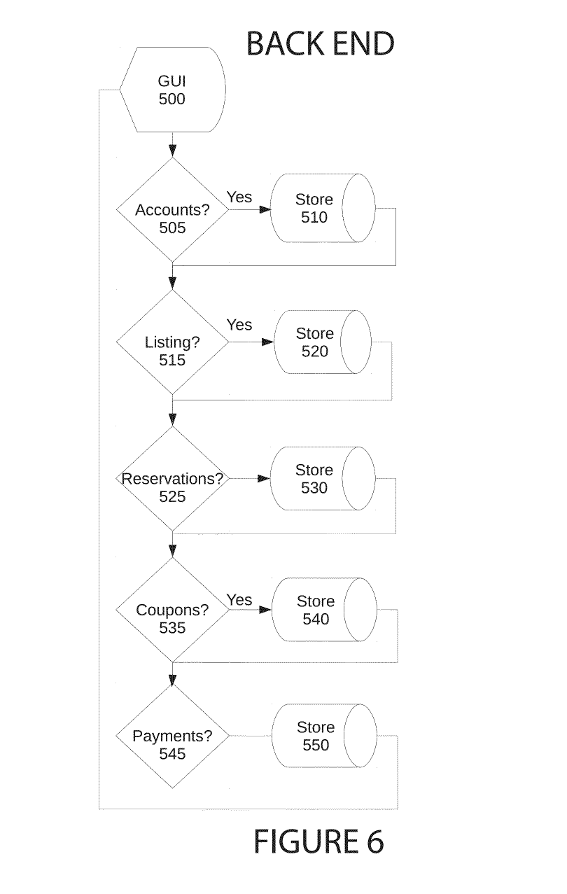

Referring now to FIG. 6, a high level flowchart of functions of an exemplary back end for an exemplary system to facilitate, track and reward recommendations of goods and services according to principles of the invention is provided, back-end functions may be accessed through a user interface and/or application programming interface (API) 500. The back-end 240 stores data related to all functions, provides data necessary for promoter app and provider app functions, and negotiates transmission of notices. If provider or promoter account data is provided 505 to the back-end 240, the account information is stored 510 by the back-end 240. If promoter listing data is provided 515 to the back-end 240, the listing information is stored 520 by the back-end 240. Listing data may include data for offers created by providers. If provider or promoter reservation data is provided 525 to the back-end 240, the reservation data is stored 530 by the back-end 240. If provider coupon data is provided 535 to the back-end 240, the coupon data is stored 540 by the back-end 240. If provider or promoter payment or account data is provided 545 to the back-end 240, the payment or account data is stored 550 by the back-end 240. The back-end 240 also causes the provider to be notified of promoter recommendations. The back-end may also transmit information for a recommendation to a patron. The back-end may also transmit reservation data to all parties (i.e., the promoter, the patron and the provider). The Additionally, compensation is managed and effectuated by the back-end. Provider payments are sent to the back-end or to an account managed by the back-end, which may deduct a fee and pay the balance, equal to the offered compensation, to the provider.

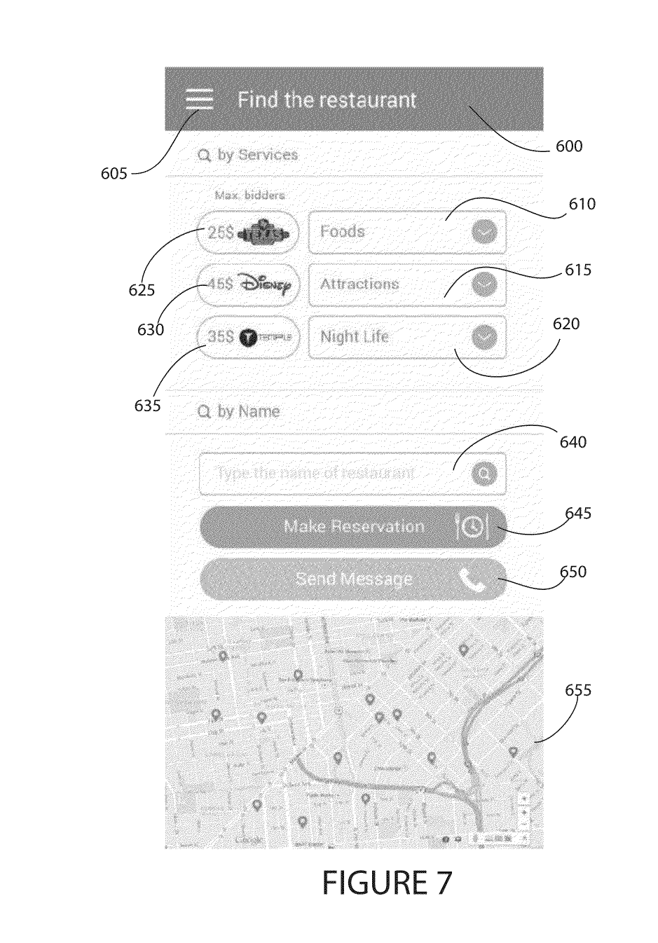

A method according to the principles of the invention offers substantial improvement in exposure and advertisement of providers to consumers, by compensating promoters. As discussed above, the provider and the promoter are registered to an application, which may be the same application with separate functions and configurations for providers and promoters, or may be two separate applications—one for a provider and one for a promoter. Information and profiles are saved in the application server back-end. After a user, such as a provider or promoter, signs-in for the first time, the system may run in the background and sign the user in automatically after power-on. An exemplary main screen for the promoter 600 may include a list of highest paying providers 625, 630, 635, by category 610, 615, 620, with options to search 640 by name or type of provider, and additional options to display the results graphically on a map 655 using principles of geographic information systems, with details showing upon selection, touch, mouse over or zoom, as shown in FIG. 7. App settings may be configurable through an options menu 605, using Messages 650, such as email and/or SMS messages, may be sent from the promoter to a provider. An interaction may start when a potential patron asks a promoter for a recommendation, or when a promoter offers a recommendation to a potential patron. A potential patron may accept or deny a recommendation. Even if a potential patron does not ask for a reservation, the promoter may still make a reservation 645. If the potential patron accepts a recommendation and asks for a reservation, the promoter may send either a reservation request or proposed reservation, with the reservation details, to the provider. If a reservation is accepted by a provider, then the promoter receives a notification. When the potential patron arrives at the provider's business, the event may be captured by time of GPS location and the provider may receive a system notification and receive payment. The event of payment is recorded by the server of the application on the back-end.

A main screen 700 for a provider may include controls such as buttons and scrollbars 710, as conceptually illustrated in FIG. 7. In particular, there may be scrollbar 710 providing an ability of setting promoter compensation. Each time this level is modified, it will be updated on the back-end server and used going forward in every promoter application. App settings may be configurable through an options menu 705. Levels of compensation may be defined in a scheduler for a particular day and time period. In other words, the system allows associating a compensation with particular days or dates and times. This allows a provider to maximize compensation when business is expected to be slow, and minimize or eliminate compensation when business is expected to be brisk. A provider may also change the compensation in real time. Historical compensation data 715 for the provider may be accessed and reviewed. Compensation may be canceled (i.e., deactivated) when referrals are not needed. Pending reservations 725 may be reviewed. A description 730 of the provider may entered and modify periodically. An audio recording may accompany the textual description. The description 730 may be sent to the back-end for presentation to promoters. A map 745 may graphically illustrate locations of prospective patrons, particularly promoters transporting such patrons, or other relevant information.

When a reservation request is received by a provider, it might be accepted, denied or countered with another time. In all cases, a corresponding notification is sent to the promoter application, which may cause trigger a pop-up window with a notification.

After a reservation is made or a recommendation code is issued, the system may capture an expected patron arrival time and wait for the patron arrival, based on the GPS coordinates. When the patron arrives (according to the promoter notification) the system may provide arrival notification by a notification pop-up window message. A provider may confirm arrival, based upon interaction between the provider and patron. Optionally, if there is no such interaction, the system may determine that the patron arrived after a particular time period (e.g., 10 min.) following a reservation. As another option, arrival may be determined by location information (e.g. GPS) from the patron's smartphone. Payment will be transferred to the promoter after arrival and this event will be recorded in the back-end. If a patron does not arrive for any particular reason or after a determined period of time, an alert may pop-up for the provider with the ability for the provider to call or send message or SMS to the promoter. In that case, the provider may either confirm the patron's arrival manually by contacting the patron or cancel the reservation. In case of cancellation the system may require a reason for cancellation, which will be recorded by the back-end system server and reported to the promoter.

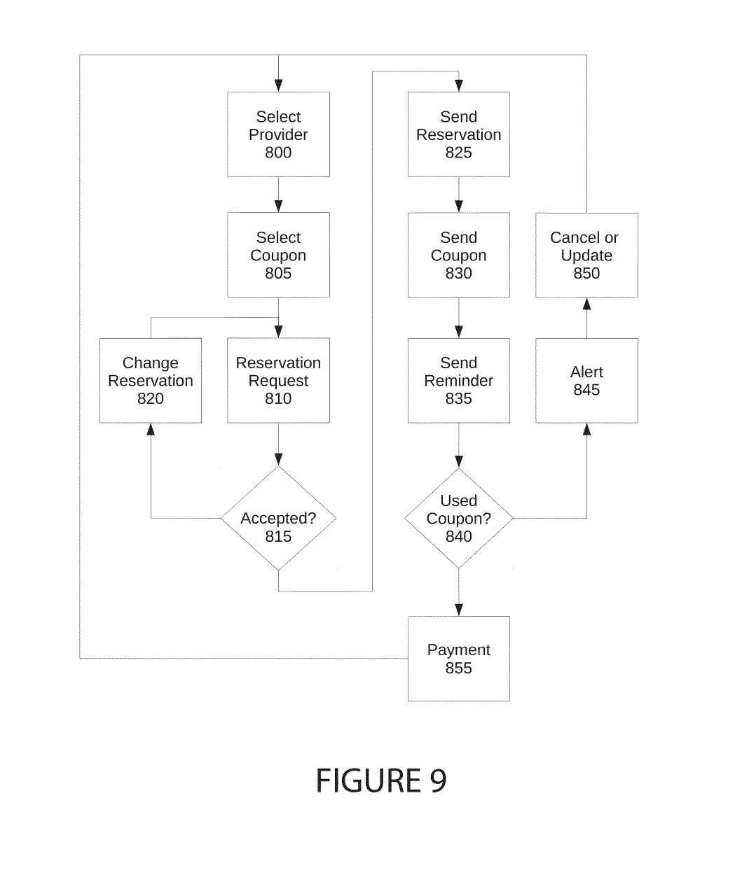

As another illustrative example, with reference to FIG. 9, a session between a promoter and a provider starts when a promoter selects 800, using the promoter app, a particular provider from a list. The selection may be made according to advertised selection parameters, such as popularity, promotion compensation, patron preferences etc. Once a provider has been selected, a coupon library may be displayed and can be introduced to a potential patron. All coupons in the library are prepared by the provider and made available for selection by prospective patrons 805 directly or through a promoter. After a promoter selects an intrinsic coupon 805 on behalf of a patron and requests a reservation and time 810, the system requests that the provider confirm (i.e., accept) the intrinsic coupon, reservation and time 815. Upon confirmation by the provider, the reservation is finalized and sent to the provider 825. If the provider declines the reservation, the system may negotiate and change conditions (e.g., change the time of the reservation or any other reservation condition) in order to get the reservation confirmed 820.

Along with a reservation confirmation, the system sends a coupon unique ID (e.g., a multi-digit number), QR code or other identifiable indicia, to the patron 830.

The system tracks the time and provides a follow-up (i.e., reminder) to the reservation 835. The system waits until the preset activation time. At that time the system sends a reminder notification 835. At the reservation time, coupon usage is captured by entering the coupon ID number (or scanned via QR code), which assures the patron's arrival and coupon usage 840. If the system receives the appropriate coupon ID, then a payment transaction is initiated 855 to compensate the promoter for the recommendation and patronage by the patron. If the coupon is not captured at a reservation time, an alert 845 may be sent to the promoter and to the potential patron. Then the reservation can either be updated in terms of a new time negotiated by the promoter in consultation with the potential patron or canceled 850. In that case the reservation cycle starts from the beginning.

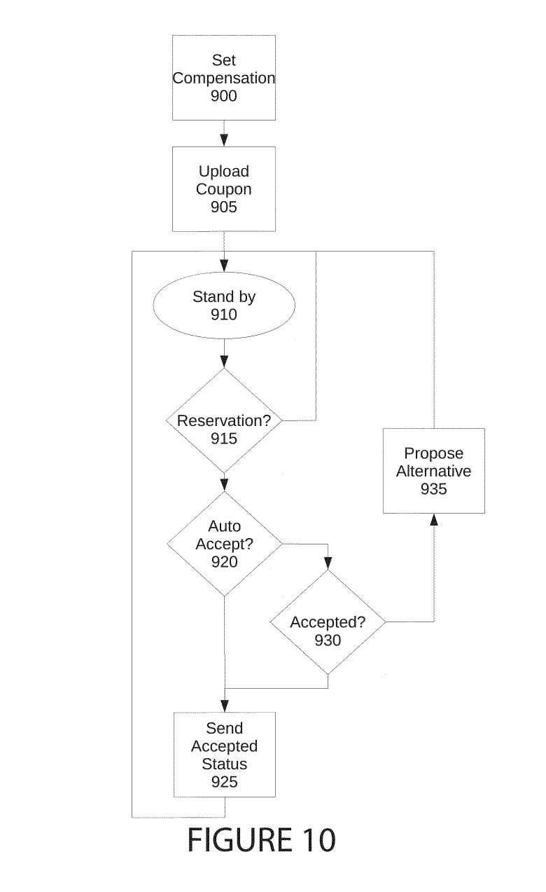

With reference to FIG. 10, the provider defines the level of compensation 900 for promoting the service that the promoter will be earn, once a reservation is honored by a patron. The compensation level can be set any time, in order to encourage promoters to take action.

A provider may build and upload a set of coupons 905, according to a schedule and parameters (such as date, time of the day etc.). A scheduler will activate only the coupons without scheduling restrictions or with restrictions that allow use of the coupon on the system at the then current time.

The provider app may remain in stand-by 910 until initiated. In the event of an incoming reservation initiated by a promoter (as described above) 915, a provider has the option of declining the reservation due to any number of reasons (e.g., insufficient capacity or other conditions). Unless declined, a reservation may be accepted by the promoter. Acceptance may occur automatically 920 after a determined amount of time elapses, for all incoming reservations, if an automatic acceptance function is activated. Alternatively, the provider may review every incoming reservation and accept it manually 930, in order to meet reservation conditions and requirements. In either case, each reservation can be accepted or declined.

If a reservation is accepted then a notification is sent to the promoter and the status of the reservation is updated to “reservation accepted” 925. If the provider is unable to meet the requirements of reservation (e.g., lack of available seating etc.), the provider can negotiate acceptable reservation conditions (such as time, place, etc.) and then the provider can resend the reservation with new acceptable conditions, so it can be accepted by the provider 935.

In one example, the promoter may be a cab driver or concierge. The patron may be a passenger or guest. The patron may ask the promoter to recommend a local Japanese restaurant. Using the promoter apparatus (i.e., the promoter application running on a computing device such as a smart phone), the promoter looks up participating Japanese restaurants, and selects one. The information presented to the promoter may include information about the restaurant, the restaurant's menu, reviews for the restaurant, and information about the compensation offered by the restaurant for a referred patron using the system. The promoter may discuss one or more participating Japanese restaurants with the patron. The promoter then selects one of the participating Japanese restaurants on behalf of the patron and enters a time for a reservation for the patron. Additional information may also be entered for the reservation, such as the number of people in the patron's party. The selected provider receives the reservation via the provider apparatus (i.e., a provider application running on a computing device such as a smart phone). The provider has an opportunity to accept, reject, or re-negotiate the reservation. For example, if the restaurant has available seating at the reservation time, the restaurant is likely to accept the reservation. If the restaurant lacks available seating at the requested time, the restaurant may propose an alternative time. After a reservation is accepted, data such as a coupon or coupon code is sent to the patron by the system. A provider may create various coupons and coupon codes to be made available to patrons on certain dates, at certain times, and/or until deleted from the system by the provider. The data may be sent as a text (SMS) or email to a number or address provide by the patron, or to a compatible patron application used by the patron. If the patron appears at the restaurant at about the time of the reservation, the patron may present the data (e.g., coupon) to the restaurant staff. Presentment of the data may be a condition for checking-in under the reservation and/or may be a condition for a discount. Using the provider app, the restaurant staff scans or otherwise enters the data, thereby indicating that the patron has used the data in accordance with the reservation. Upon such use, the promoter is compensated by the provider for the referred patron.

The embodiments and implementations described above refer separately to recommendations and reservations. Some providers may not accept reservations, in which case all reservation functions and steps may be omitted. Some providers may require reservations, in which case the recommendation may be merged with the reservation function and steps. In that case, a reservation may be made without a separate procedure for recommendation.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A compensating promotion system comprising:
a provider application executing on a provider computing device in the possession of a provider;
a promoter application executing on a promoter cellular phone in the possession of a promoter;
a patron cellular phone configured to wirelessly receive objects;
the promoter application selecting an identification of the provider from a plurality of identifications of available providers, the patron electing to provide patronage to the provider;
the promoter application causing a unique object to be sent to the patron cellular phone; and
the provider application causing a payment to be made to the provider upon presentation of the unique object to the provider by the patron at a time of patronage.

2. The compensating promotion system according to claim 1, said unique object comprising numeric data.

3. The compensating promotion system according to claim 1, said unique object comprising alphanumeric data.

4. The compensating promotion system according to claim 1, said unique object comprising coupon data.

5. The compensating promotion system according to claim 1, said unique object comprising barcode data.

6. The compensating promotion system according to claim 1, the promoter application communicating a reservation request to the provider application, the reservation request corresponding to the time of patronage.

7. The compensating promotion system according to claim 6, the provider application communicating an acceptance of the reservation request to the promoter application.

8. The compensating promotion system according to claim 6, the provider application communicating a rejection of the reservation request to the promoter application.

9. The compensating promotion system according to claim 8, the provider application communicating an alternative reservation proposal along with the rejection of the reservation request to the promoter application.

10. The compensating promotion system according to claim 1, the payment to be made to the provider upon presentation of the unique object to the provider by the patron at a time of patronage being a payment predetermined by the provider and communicated to the promoter application.

11. The compensating promotion system according to claim 1, the payment to be made to the provider upon presentation of the unique object to the provider by the patron at a time of patronage being a payment from a plurality of scheduled payments, each of the plurality of scheduled payments corresponding to a patronage time, the payment to be made to the provider upon presentation of the unique object to the provider by the patron at a time of patronage corresponding to the time of patronage.

12. A compensating promotion method comprising steps of:
executing a provider application on a provider computing device in the possession of a provider;
executing a promoter application on a promoter cellular phone in the possession of a promoter;
the promoter application selecting an identification of the provider from a plurality of identifications of available providers, a patron in communication with the promoter electing to provide patronage to the provider;
the promoter application causing a unique object to be sent to a patron cellular phone in the possession of the patron and configured to wirelessly receive objects; and
the provider application causing a payment to be made to the provider upon presentation of the unique object to the provider by the patron at a time of patronage.

13. The compensating promotion method according to claim 12, said unique object comprising numeric data.

14. The compensating promotion method according to claim 12, said unique object comprising alphanumeric data.

15. The compensating promotion method according to claim 12, said unique object comprising coupon data.

16. The compensating promotion method according to claim 12, said unique object comprising barcode data.

17. The compensating promotion method according to claim 12, the promoter application communicating a reservation request to the provider application, the reservation request corresponding to the time of patronage.

18. The compensating promotion method according to claim 17, the provider application communicating an acceptance of the reservation request to the promoter application.

19. The compensating promotion method according to claim 17, the provider application communicating a rejection of the reservation request to the promoter application.

20. The compensating promotion system according to claim 19, the provider application communicating an alternative reservation proposal along with the rejection of the reservation request to the promoter application.
